(19) United States
(12) Patent Application Publication
(10) Pub. No.: US 2025/0190853 A1
(43) Pub. Date: Jun. 12, 2025

(54) ENHANCING IN-CONTEXT LEARNING WITH FOUNDATION MODELS VIA FEW-SHOT LINEAR PROBE CALIBRATION

(71) Applicants: International Business Machines Corporation, Armonk, NY (US); Rensselaer Polytechnic Institute, Troy, NY (US)

(72) Inventors: Momin Abbas, New York, NY (US); Yi Zhou, San Jose, CA (US); Parikshit Ram, Atlanta, GA (US); Nathalie Baracaldo Angel, San Jose, CA (US); Horst Cornelius Samulowitz, Armonk, NY (US); Theodoros Salonidis, Wayne, PA (US); Tianyi Chen, Rensselaer, NY (US)

(21) Appl. No.: 18/536,177

(22) Filed: Dec. 11, 2023

(51) Int. Cl. G06N 20/00; G06N 7/01

(52) U.S. Cl. CPC G06N 20/00; G06N 7/01

(57) ABSTRACT

Aspects provide in-context learning with calibration for a foundation model. A validation prompt including one or more demonstration samples and an evaluation example is received and an output probability generated using the foundation model and the validation prompt. A calibration loss is computed based on the output probability and a set of calibration parameters. The set of calibration parameters is updated based on the calibration loss using an optimization algorithm. An inferencing operation is performed using the updated calibration parameters.

### BACKGROUND

The present invention relates generally to the electrical, electronic and computer arts and, more particularly, to machine learning.

In-context learning (ICL) is a method of prompt engineering (i.e., the engineering of prompts directed to a user). Demonstrations of the task are input in natural language into the machine learning model via the prompt. ICL is sensitive to varying prompt templates, demonstration permutations, label proportions and the like. The efficacy of ICL is also restricted by a maximum sequence length limit of a tokenizer of the corresponding large language model (LLM). In general, the predictions made by ICL may be unreliable.

### BRIEF SUMMARY

Principles of the invention provide systems and techniques for enhancing in-context learning with foundation models via few-shot linear probe calibration. In one aspect, an exemplary method includes the operations of receiving, using at least one hardware processor, a validation prompt comprising one or more demonstration samples and an evaluation example; generating, using, the at least one hardware processor and the foundation model and the validation prompt, an output probability; computing, using the at least one hardware processor, a calibration loss based on the output probability and a set of calibration parameters; updating, using the at least one hardware processor and an optimization algorithm, the set of calibration parameters based on the calibration loss; and performing, using the at least one hardware processor, an inferencing operation using the updated calibration parameters.

In one aspect, a computer program product comprises one or more tangible computer-readable storage media and program instructions stored on at least one of the one or more tangible computer-readable storage media, the program instructions executable by a processor, the program instructions comprising receiving a validation prompt comprising one or more demonstration samples and an evaluation example; generating, using the foundation model and the validation prompt, an output probability; computing a calibration loss based on the output probability and a set of calibration parameters; updating, using an optimization algorithm, the set of calibration parameters based on the calibration loss; and performing an inferencing operation using the updated calibration parameters.

In one aspect, an apparatus comprises a memory and at least one processor, coupled to the memory, and operative to perform operations comprising receiving a validation prompt comprising one or more demonstration samples and an evaluation example; generating, using the foundation model and the validation prompt, an output probability; computing a calibration loss based on the output probability and a set of calibration parameters; updating, using an optimization algorithm, the set of calibration parameters based on the calibration loss; and performing an inferencing operation using the updated calibration parameters.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improvements to the technical field of machine learning by creating more robust and higher quality prompts (based, for example, on user questions) that generate improved inferencing results (such as answers to questions);
improvements to the technical field of machine learning by generating an output probability using a foundation model and a validation prompt; computing a calibration loss based on the output probability and a set of calibration parameters; and updating the set of calibration parameters based on the calibration loss;
improvements to the technical field of machine learning by using in-context machine learning (ICL) to eliminate the need for large sets of training samples, thereby generating stable model performance for foundation models;
in-context learning that provides a computationally efficient solution for machine learning since it does not require any training (a few or zero data samples served as demonstrations for comparing exemplary embodiments to other conventional tuning methods);
practically relevant with generative pre-trained transformer (GPT)-like models;
effective machine learning models even when trained with only a few samples (typically on the order of 0-16 samples) depending on the model input size;
machine learning models that each support many downstream tasks; and
models that generally require no machine learning expertise to run.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a workflow for an example in-context machine learning system, in accordance with an example embodiment;

FIG. 2A is a graph of the test accuracy vs. number of shots on each of three conventional datasets, in accordance with example embodiments;

FIG. 2B illustrates Shannon entropy histograms based on using conventional in-context learning on a conventional transformer-based language model vs. exemplary embodiments on a first conventional dataset, in accordance with aspects of the invention;

FIG. 3 illustrates the mathematical representation of a prompt, in accordance with an example embodiment;

FIG. 4 is a flowchart for an example method for performing linear probe calibration, in accordance with an example embodiment;

FIG. 5 is an example algorithm for linear probe calibration, in accordance with an example embodiment;

FIG. 6A is a table illustrating the results for the three baseline techniques using the eight conventional datasets and 0, 1, 4, and 8 shots on the first conventional generative pre-trained transformer LLM, in accordance with an example embodiment;

FIG. 6B is a table illustrating the results for the three baseline techniques using the eight conventional datasets and 0, 1, 4, and 8 shots on the second conventional generative pre-trained transformer LLM, in accordance with an example embodiment;

FIG. 7A is a plot of the difference in standard deviation between the calibration methods and the unadjusted baseline (no calibration) of FIG. 6A, in accordance with an example embodiment;

FIG. 7B illustrates a performance comparison across six different templates, in accordance with an example embodiment;

FIG. 8 is a graph illustrating a performance comparison under varying label proportions and permutations of demonstrations, in accordance with an example embodiment;

FIG. 9 is a graph illustrating a performance comparison across varying validation sizes, in accordance with an example embodiment; and

FIG. 10 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Few-Shot Learning with Large Learning Models

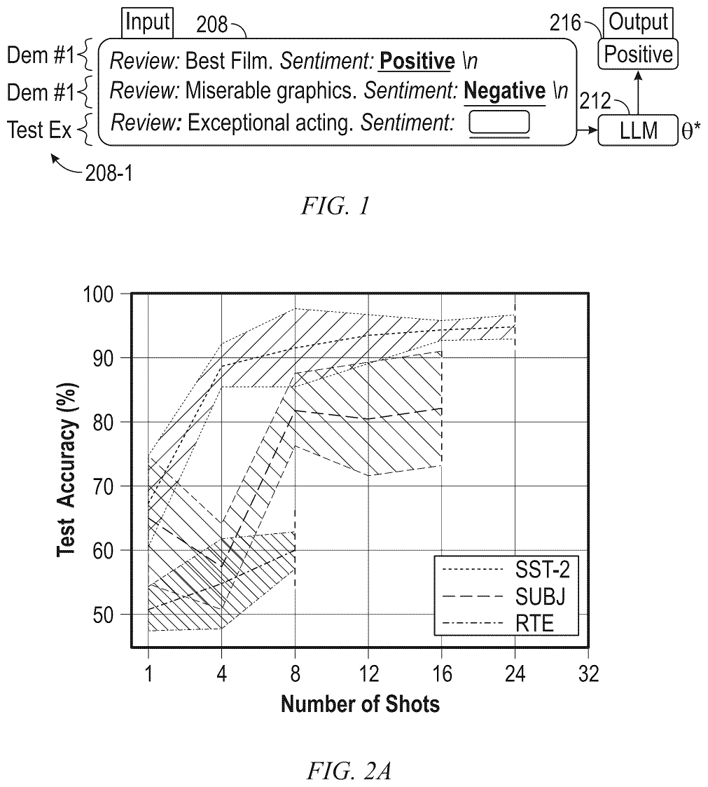

FIG. 1 is a workflow for an example in-context machine learning system, in accordance with an example embodiment. Input 208 is provided to a large language model 212 and a classification output 216 is generated. For example, a test input 208-1 is classified as having positive sentiment 216 by the large language model 212.

### In-Context Learning

In one example embodiment, an in-context learning (ICL) approach provides a computationally efficient solution for machine learning that does not require any training. In terms of an exemplary practical application, it is relevant, e.g., with generative pre-trained transformer (GPT)-like models and is effective even when trained with only a few samples (typically on the order of 0-16 samples). ICL supports many tasks with one model and generally requires no machine learning expertise to run.

### Limitations of In-Context Learning

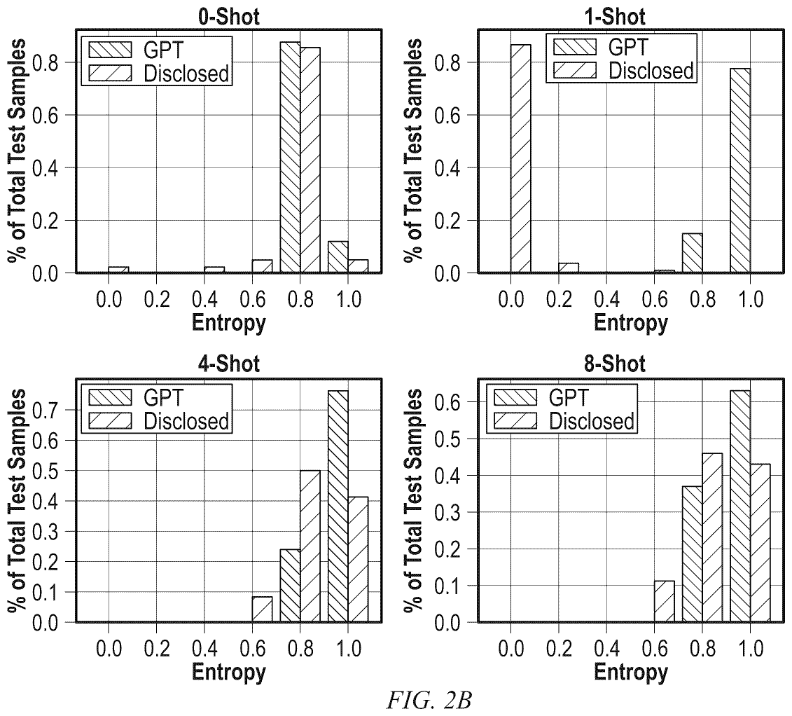

As noted above, ICL is sensitive to varying prompt templates, demonstration permutations, label proportions and the like. The efficacy of ICL is also restricted by a maximum sequence length limit of a tokenizer of the large language model (LLM) 212. The predictions made by ICL may be unreliable. To improve ICL, current approaches require a large amount of data (such as greater than 1000 data samples where data samples correspond to example input-output pairs). FIG. 2A is a graph of the test accuracy vs. number of shots on each of three conventional datasets, in accordance with example embodiments. It is also observed that, beyond a certain point, no additional demonstrations can be added within the prompt since the model reaches its maximum sequence length limit. Therefore, the potential for performance enhancement through the acquisition of more examples is often constrained by this limitation of ICL, even in few-shot settings.

FIG. 2B illustrates Shannon entropy histograms based on using conventional in-context learning on a conventional transformer-based language model vs. an exemplary embodiment on a first conventional dataset, in accordance with an example embodiment. (Higher entropy implies higher uncertainty; logarithmic base two was used.) It is observed that, in contrast to the performance of an example embodiment, using conventional ICL on GPT leads to high values of entropy, implying that most test predictions were made with very low confidence, i.e., close to random guessing. This observation indicates that, although vanilla ICL (i.e., uncalibrated) on GPT yields satisfactory results in terms of test accuracy, the confidence associated with these predictions is not entirely reliable.

### Linear Probe Calibration (LinC)

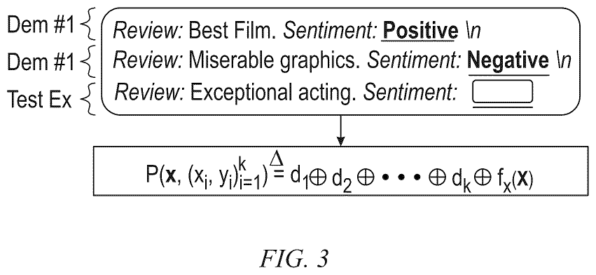

FIG. 3 illustrates the mathematical representation of a prompt, in accordance with an example embodiment. The prompt can be mathematically represented as:

$$P ( x , {( {x}_{i} , {y}_{i} )}_{i = 1}^{k} ) {=}^{△} {d}_{1} ⊕ {d}_{2} ⊕ … ⊕ {d}_{1} ⊕ {f}_{x} ( x )$$

where each demonstration dᵢ is given by fₓ(xᵢ)⊕f_{y}(yᵢ), ⊕ denotes the concatenate operation, and fₓ(⋅),f_{y}(⋅) denote template functions that attach pre-defined descriptions to the input and output (italicized text). A model M_{θ*} is considered parameterized by θ* such that the output probability is given by:

$$p ( P ( x , {( {x}_{i} , {y}_{i} )}_{i = 1}^{k} ) ) {=}^{△} {M}_{{θ}^{*}} ( P ( x , {( {x}_{i} , {y}_{i} )}_{i = 1}^{k} ) )$$

In one example embodiment, the output probabilities of the model are linearly calibrated:

$$\tilde{p} = softmax ( Ap + b )$$

where A and b are parameters to be applied to the original probabilities p to get new probabilities \tilde{p}.

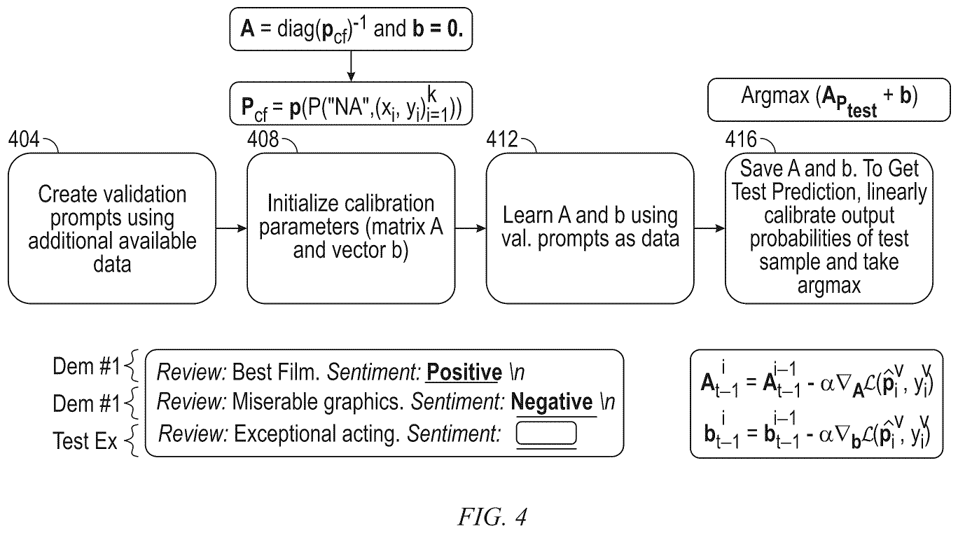

FIG. 4 is a flowchart for an example method for performing linear probe calibration, in accordance with an example embodiment. In one example embodiment, validation prompts are created using additional available data (operation 404). Calibration parameters (matrix A and vector b) are initialized (operation 408). In one example embodiment, A=diag(p_{cf})⁻¹ and b=0 where p_{cf}=p(P(“NA”,(xᵢ,yᵢ)ᵢ₌₁^{k})). Matrix A and vector b are learned using an optimization method, such as stochastic gradient descent (SGD), and using the validation prompts as data (operation 412). In one example embodiment, Aₜ₋₁ⁱ=Aₜ₋₁ⁱ⁻¹−Δ∇_{A} [symbol] (\hat{p}ᵢ^{v},yᵢ^{v}) and bₜ₋₁ⁱ=bₜ₋₁ⁱ⁻¹−α∇_{b} [symbol] (\hat{p}ᵢ^{v},yᵢ^{v}). Matrix A and vector b are saved (operation 416). To get test prediction, output probabilities of a test sample are linearly calibrated and an argmax is taken (argmax (Apₜₑₛₜ+b)) (operation 416).

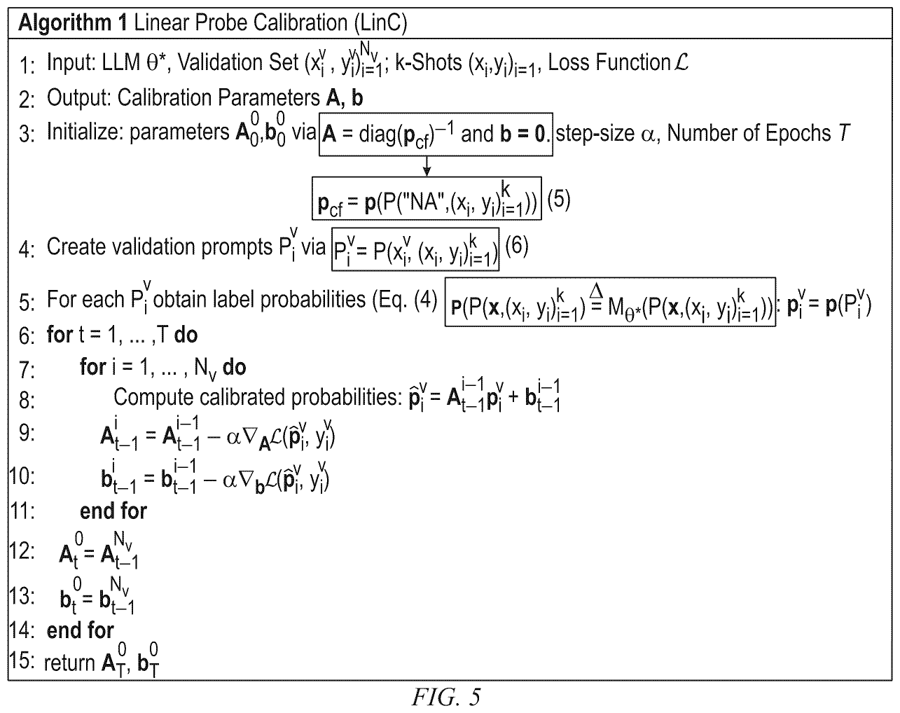

FIG. 5 is an example algorithm for linear probe calibration, in accordance with an example embodiment. In one example embodiment, calibration parameters, matrix A and vector b, are output by the algorithm of FIG. 5 (line 2). Parameters A₀⁰, b₀⁰ are initialized (A=diag(p_{cf})⁻¹ and b=0) based on p_{cf}=p(P(“NA”,(xᵢ,yᵢ)ᵢ₌₁^{k})), and step-size a and number of epochs T are initialized (line 3). Validation prompts Pᵢ^{v} are created via Pᵢ^{v}=P(xᵢ^{v},(xᵢ,yᵢ)ᵢ₌₁^{k}) (line 4). For each Pᵢ^{v}, obtain label probabilities: pᵢ^{v}=p(Pᵢ^{v}) based on p(P(x,(xᵢ,yᵢ)ᵢ₌₁^{k}))≙M_{θ*}(P(x,(xᵢ,yᵢ)ᵢ₌₁^{k})) (line 5). The calibrated probabilities are computed based on \hat{p}ᵢ^{v}=Aₜ₋₁ⁱ⁻¹pᵢ^{v}+bₜ₋₁ⁱ⁻¹ (lines 6-11). The parameters A and b are computed based on:

$${A}_{t - 1}^{i} = {A}_{t - 1}^{i - 1} - α {∇}_{A} ℒ ( {\hat{p}}_{i}^{v} , {y}_{i}^{v} )$$

$${b}_{t - 1}^{i} = {b}_{t - 1}^{i - 1} - α {∇}_{b} ℒ ( {\hat{p}}_{i}^{v} , {y}_{i}^{v} ) .$$

Aₜ⁰=Aₜ₋₁^{N}^{ᵥ}, and bₜ⁰=bₜ₋₁^{N}^{ᵥ} (lines 12-13).

### Experiments

Experiments were conducted on eight conventional graphics processing units (GPUs) for a variety of datasets and tasks, including the first conventional dataset (sentiment analysis), the second conventional dataset (sentiment analysis), the third conventional dataset (topic classification), the fourth conventional dataset (topic classification), the fifth conventional dataset (question classification), the sixth conventional (textual entailment), and the seventh conventional dataset (subjectivity classification).

Two baseline techniques were considered: conventional ICL (i.e., no calibration) and contextual calibration using two conventional large language models 212: a first conventional generative pre-trained transformer and a second conventional generative pre-trained transformer. The number of shots were 0, 1, 4, and 8.

### Results

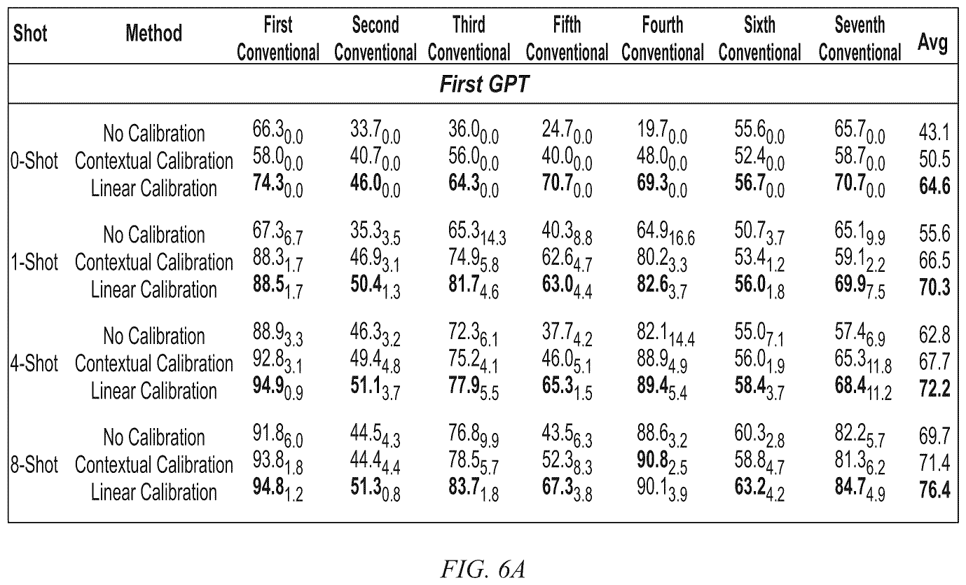

FIG. 6A is a table illustrating the results for the two baseline techniques and an example embodiment (Linear Calibration) using the eight conventional datasets and 0, 1, 4, and 8 shots on the first conventional generative pre-trained transformer LLM 212, in accordance with an example embodiment. FIG. 6B is a table illustrating the results for the two baseline techniques using the eight conventional datasets and 0, 1, 4, and 8 shots on the second conventional generative pre-trained transformer LLM 212, in accordance with an example embodiment. Linear calibration demonstrates strong generalization ability across different model sizes and few-shot settings. On average, linear calibration achieves up to 21% improvement as compared to the existing ICL baseline and 14% improvement as compared to contextual calibration for 0-shot learning on the first conventional generative pre-trained transformer. In certain cases, linear calibration can deliver a significant boost in performance, e.g., up to 50% absolute improvement.

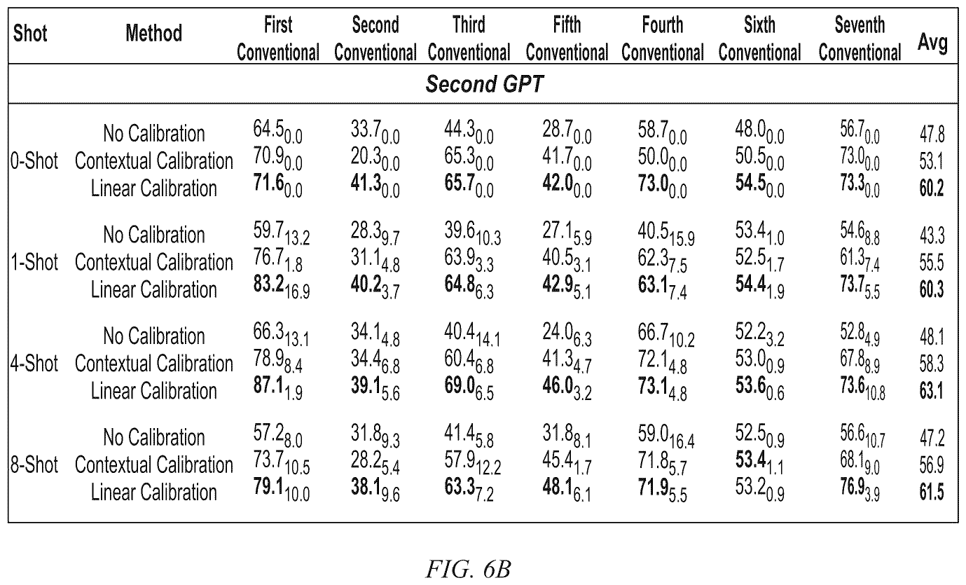

FIG. 7A is a plot of the difference in standard deviation between the calibration methods and the unadjusted baseline (no calibration) from FIG. 6A, in accordance with an example embodiment. FIG. 7A illustrates how linear calibration diminishes the standard deviation of accuracy across different choices of demonstrations. FIG. 7B illustrates a performance comparison across six different templates, in accordance with an example embodiment. Linear calibration significantly reduces variance while only slightly increasing it in the remaining cases. On average, linear calibration achieves a greater reduction in standard deviation than contextual calibration, indicating that the predictions made by linear calibration are more consistent and reliable. Linear calibration exhibits a considerable enhancement in accuracy with much lower variance, demonstrating its effectiveness in improving the model's performance across various prompt templates.

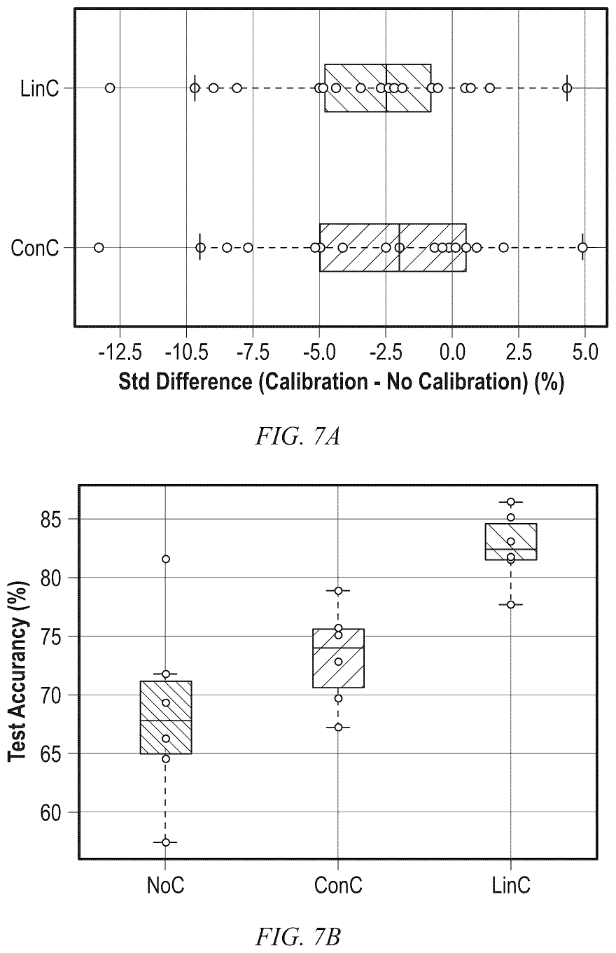

FIG. 8 is a graph illustrating a performance comparison under varying label proportions and permutations of demonstrations, in accordance with an example embodiment. As illustrated in FIG. 8, each box represents the test accuracy obtained from eight random permutations (NoC corresponds to no calibration or conventional ICL; ConC corresponds to contextual calibration; and LinC corresponds to linear calibration). Linear calibration stands out as the most effective model and displays remarkably low variance across different permutations, suggesting that it is robust to varying class proportions and permutations.

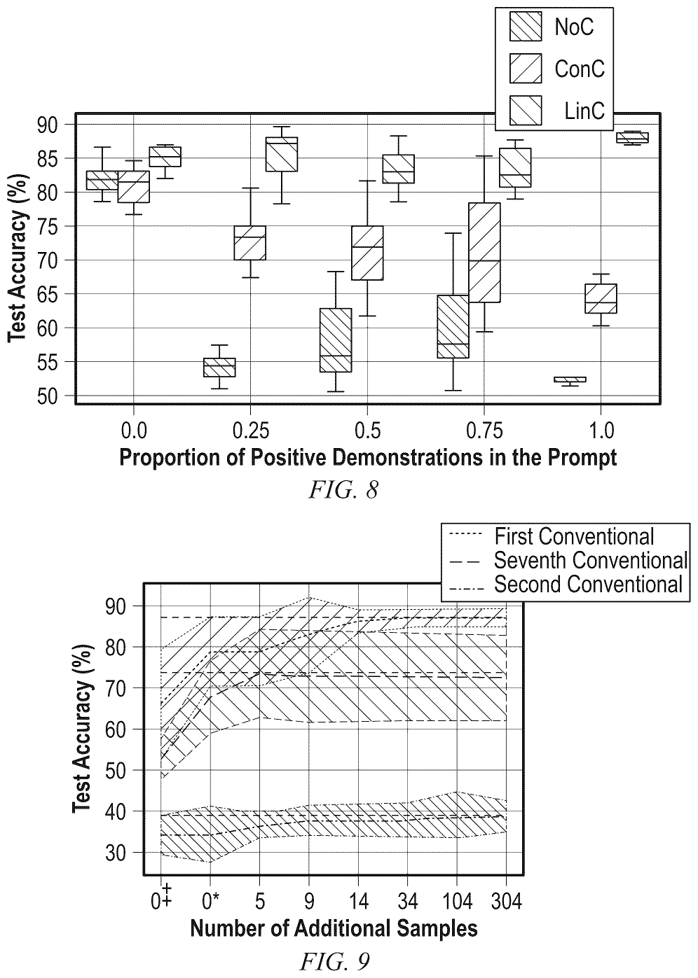

FIG. 9 is a graph illustrating a performance comparison across varying validation sizes, in accordance with an example embodiment. (‡ denotes no calibration and * denotes contextual calibration. The black dotted line marks the maximum accuracy.) Performance can be greatly improved by increasing the number of validation samples within a certain small range. However, further increasing the number of samples does not yield any additional improvement. Linear calibration demonstrates high sample efficiency, achieving maximum accuracy with less than 30 additional samples on most datasets. Some datasets require only five additional samples to achieve maximum accuracy.

Returning to FIG. 2B, in contrast to the performance of an exemplary embodiment, using conventional ICL on GPT leads to high values of entropy, implying that most test predictions were made with very low confidence, i.e., close to random guessing. This observation indicates that, although conventional ICL (i.e., uncalibrated ICL) on GPT yields satisfactory results in terms of test accuracy, the confidence associated with these predictions is not entirely reliable.

Given the discussion thus far, it will be appreciated that, in general terms, an exemplary method, according to an aspect of the invention, includes the operations of receiving, using at least one hardware processor, a validation prompt comprising one or more demonstration samples and an evaluation example; generating, using, the at least one hardware processor and the foundation model and the validation prompt, an output probability; computing, using the at least one hardware processor, a calibration loss based on the output probability and a set of calibration parameters; updating, using the at least one hardware processor and an optimization algorithm, the set of calibration parameters based on the calibration loss; and performing, using the at least one hardware processor, an inferencing operation using the updated calibration parameters.

In one example embodiment, the validation prompt is a concatenation of one or more demonstration samples and the evaluation example.

In one example embodiment, the validation prompt includes the evaluation example; in some such instances, the validation prompt consists only of the evaluation example

In one example embodiment, the optimization algorithm is a stochastic gradient descent algorithm.

In one example embodiment, the computing of the calibration loss comprises using linear calibration to compute the calibration loss.

In one example embodiment, multiple validation prompts are constructed and the set of calibration parameters is repeatedly updated based on output probability distributions of the constructed validation prompts.

In one example embodiment, validation prompts are created using additional available data (operation 404); the set of calibration parameters is initialized (operation 408); and a test prediction is generated by linearly calibrating output probabilities of a test sample and taking an argmax (argmax (Apₜₑₛₜ+b)) (operation 416).

In one example embodiment, the inferencing operation is granting access to a network resource based on an inferencing result.

In one example embodiment, the inferencing operation is granting access to a physical space by opening a barrier based on an inferencing result.

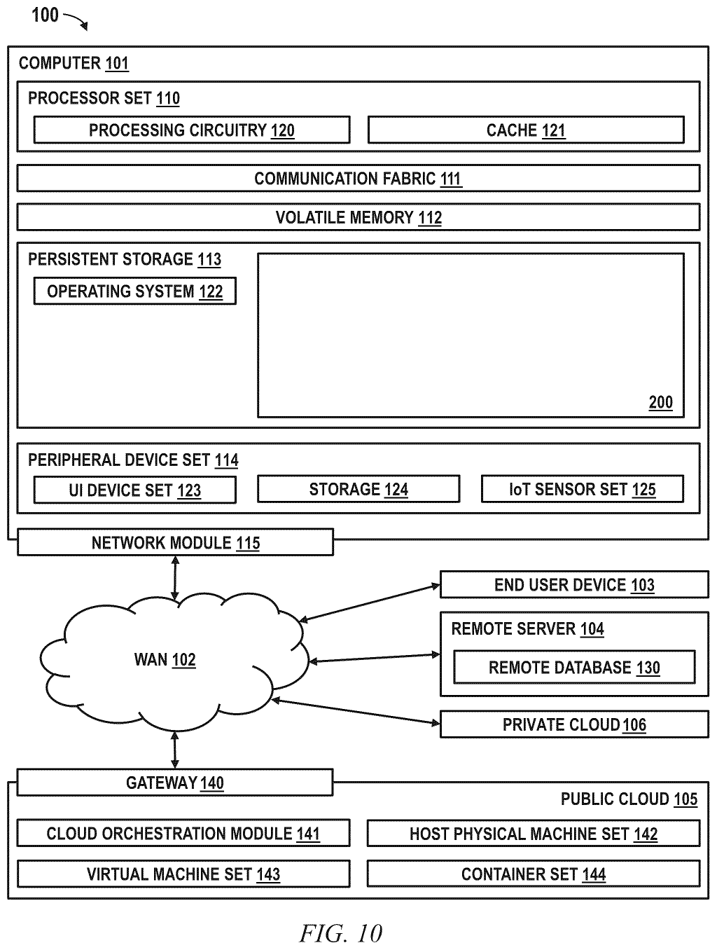

Access can be granted to a resource, or by opening a barrier, based, for example, on a signal sent over WAN 102 in FIG. 10, or over a LAN, cable, wireless link, etc.

In one aspect, a computer program product comprises one or more tangible computer-readable storage media and program instructions stored on at least one of the one or more tangible computer-readable storage media, the program instructions executable by a processor, the program instructions comprising receiving a validation prompt comprising one or more demonstration samples and an evaluation example; generating, using the foundation model and the validation prompt, an output probability; computing a calibration loss based on the output probability and a set of calibration parameters; updating, using an optimization algorithm, the set of calibration parameters based on the calibration loss; and performing an inferencing operation using the updated calibration parameters.

In one aspect, an apparatus comprises a memory and at least one processor, coupled to the memory, and operative to perform operations comprising receiving a validation prompt comprising one or more demonstration samples and an evaluation example; generating, using the foundation model and the validation prompt, an output probability; computing a calibration loss based on the output probability and a set of calibration parameters; updating, using an optimization algorithm, the set of calibration parameters based on the calibration loss; and performing an inferencing operation using the updated calibration parameters.

Refer now to FIG. 10.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as in-context learning system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for performing in-context learning with calibration for a foundation model, the method comprising:
receiving, using at least one hardware processor, a validation prompt comprising one or more demonstration samples and an evaluation example;
generating, using the at least one hardware processor, the foundation model, and the validation prompt, an output probability;
computing, using the at least one hardware processor, a calibration loss based on the output probability and a set of calibration parameters;
updating, using the at least one hardware processor and an optimization algorithm, the set of calibration parameters based on the calibration loss; and
performing, using the at least one hardware processor, an inferencing operation using the updated calibration parameters.

2. The method of claim 1, wherein the validation prompt is a concatenation of one or more demonstration samples and the evaluation example.

3. The method of claim 1, wherein the validation prompt consists only of the evaluation example.

4. The method of claim 1, wherein the optimization algorithm is a stochastic gradient descent algorithm.

5. The method of claim 1, wherein the computing of the calibration loss comprises using linear calibration to compute the calibration loss.

6. The method of claim 1, further comprising constructing multiple validation prompts and repeatedly updating the set of calibration parameters based on output probability distributions of the constructed validation prompts.

7. The method of claim 1, further comprising:
creating validation prompts using additional available data;
initializing the set of calibration parameters; and
generating a test prediction by linearly calibrating output probabilities of a test sample and taking an argmax.

8. The method of claim 1, wherein the inferencing operation includes granting access to a network resource based on an inferencing result.

9. The method of claim 1, wherein the inferencing operation includes granting access to a physical space by opening a barrier based on an inferencing result.

10. A computer program product, comprising:
one or more tangible computer-readable storage media and program instructions stored on at least one of the one or more tangible computer-readable storage media, the program instructions executable by a processor, the program instructions comprising:
receiving a validation prompt comprising one or more demonstration samples and an evaluation example;
generating, using the foundation model and the validation prompt, an output probability;
computing a calibration loss based on the output probability and a set of calibration parameters;
updating, using an optimization algorithm, the set of calibration parameters based on the calibration loss; and
performing an inferencing operation using the updated calibration parameters.

11. The computer program product of claim 10, wherein the validation prompt is a concatenation of one or more demonstration samples and the evaluation example.

12. The computer program product of claim 10, wherein the computing of the calibration loss comprises using linear calibration to compute the calibration loss.

13. The computer program product of claim 10, the program instructions further comprising constructing multiple validation prompts and repeatedly updating the set of calibration parameters based on output probability distributions of the constructed validation prompts.

14. A system comprising:
a memory; and
at least one processor, coupled to said memory, and operative to perform operations comprising:
receiving a validation prompt comprising one or more demonstration samples and an evaluation example;
generating, using the foundation model and the validation prompt, an output probability;
computing a calibration loss based on the output probability and a set of calibration parameters;
updating, using an optimization algorithm, the set of calibration parameters based on the calibration loss; and
performing an inferencing operation using the updated calibration parameters.

15. The system of claim 14, wherein the validation prompt is a concatenation of one or more demonstration samples and the evaluation example.

16. The system of claim 14, wherein the validation prompt consists only of the evaluation example.

17. The system of claim 14, wherein the optimization algorithm is a stochastic gradient descent algorithm.

18. The system of claim 14, wherein the computing of the calibration loss comprises using linear calibration to compute the calibration loss.

19. The system of claim 14, the operations further comprising constructing multiple validation prompts and repeatedly updating the set of calibration parameters based on output probability distributions of the constructed validation prompts.

20. The system of claim 14, wherein the inferencing operation is granting access to a network resource based on an inferencing result.
